(19) United States
(12) Patent Application Publication
(10) Pub. No.: US 2020/0070239 A1
(43) Pub. Date: Mar. 5, 2020

(54) Special Powered Rivet Cutter

(71) Applicant: Billy H Bowman, II, New Castle, IN (US)

(72) Inventor: Billy H Bowman, II, New Castle, IN (US)

(21) Appl. No.: 16/550,235

(22) Filed: Aug. 25, 2019

Related U.S. Application Data
(60) Provisional application No. 62/723,860, filed on Aug. 28, 2018.

(51) Int. Cl. B21J 15/50; B26B 17/00

(52) U.S. Cl. CPC B21J 15/50; B26B 17/00

(57) ABSTRACT

A Special Powered Rivet Cutter for removing riveted fasteners that is made of durable and lightweight material, the cutter includes a pair of cutting jaws with cutting edges, two pivot apertures, and a power connection aperture; a top and bottom plate each with apertures over the pivot apertures; a pair of pivot pins washers and retainer nuts, to pivotally fasten the pins through the top and bottom plates and through each of the first jaw and opposite jaw, to the jaws and washer; and a pair of power pins connected to each other by a pair of span units with left and right handed fine threads and the pair of span units engaged with an externally threaded driver bar so the driver connection is driven by a power drive unit to engage the cutting edges with a rivet and to shear the rivet at the point of engagement.

### CROSS-REFERENCE TO RELATED APPLICATIONS

This application claims the benefit of U.S. Provisional Patent Application Ser. No. 62/723,860 filed Aug. 28, 2018, by Billy H. Bowman, II. The application is entitled “A Special Powered Rivet Cutter”.

### FIELD OF INVENTION

This invention relates to a Special Powered Rivet Cutter for removing riveted fasteners. More particularly, the present invention is related to a method of extracting a riveted fastener and to apparatuses used to perform such extraction. This is generally related to cutting tools, and, more particularly, to cutting tools used for cutting solid, high strength materials such as metals. Moreover, this invention relates to tools and methods for removing a rivet after it has been installed, and more specifically relates to a rivet removal tool and method which eliminates, or at least substantially reduces, the end load which must be applied to drill out a button and remove a rivet. It relates, therefore, to the removal of rivets from riveted constructions and more particularly to tools for use in such operations.

### FEDERALLY SPONSORED RESEARCH

None.

### SEQUENCE LISTING OR PROGRAM

None.

### BACKGROUND

### Field of Invention and Prior Art

As far as known, there are no special rivet cutters found that have the same features and functions as the Special Powered Rivet Cutter presented by Bowman in this application.

Rivet removal can be performed in several ways. However, to date these all have limitations and concerns. Cutting tools, as one method, are well-known. Conventional cutting tools generally include a pair of opposing jaws with sharpened edges which pivot such that the jaws can be operated to be separated and brought together, often using levers to actuate the jaws, forcing the sharpened edges against the material to be cut. The cutting stroke generally begins with the jaws being separated as the levers are moved apart, the material to be cut is inserted between the opened jaws, and the jaws are forced together as the levers are moved together, creating a force which exceeds the strength of the material within the jaws, thus cutting the material. More often than not, the cutting tool results in scratches the surface of the sheets being fastened as typically, the jaws come together in either a scissors shear cutting action, where the jaw edges overlap at the end of the cutting stroke or in a pliers cutting action, where the jaw edges abut one another at the end of the cutting stroke. The force imposed on the material is sufficient to mar and damage the sheets being held. A deficiency of the prior art is that conventional shear type cutting tools are not suitable for cutting relatively thick materials. As the thickness of the work piece increases, the cutting action becomes less efficient. With shear type cutting tools, twisting forces are developed by the non-aligned cutting members further damaging the work.

Self-piercing rivets are used in many applications in order to secure two or more work pieces together. When a self-piercing rivet is installed, it is pushed into engagement with the work pieces such that a portion of the rivet expands and the work pieces deform around the expanded portion of the rivet. The expanded portion of the rivet becomes effectively embedded or encapsulated in the work pieces, thereby securing the work pieces together. The deformation of the work pieces causes a protrusion, often referred to as a “button”, to form on the other side (i.e. the blind side) of the rivet, and the button includes the expanded portion of the rivet therein. Sometimes, it is desirable to remove a rivet after it has been installed. One example is when the work pieces have become misaligned, such as during the riveting process. Prior art practices of removing a rivet after it has been installed involve initially grinding off the button. Attempting to remove a rivet by first grinding of the button is undesirable for several reasons. The grinding operation often requires that a relatively substantial end load be applied to the button (i.e. to the grinder which engages the button). This may be very difficult to achieve in light of the position of the rivet and the particular application. Even if it is possible to grind off the rivet, it becomes very difficult to push out the rivet because of the uneven ground surface. Lining up of a push out tool to the ground rivet is done by sight, which may be difficult if the rivet is in a position that is hard to see. This may also distort the hole if not lined up properly making it less likely to put a rivet back in the hole. Additionally, if the grinder slips during the grinding, it may mar the work piece. Finally, the grinding causes dust to spray into the air. This is undesirable and may create a workplace hazard, especially if the dust which sprays into the air is toxic.

Other types of prior rivet removers are proportioned for use with rivets of a particular size or limited range of sizes. Thus a number of such tools of different sizes are needed for optimum performance in extracting rivets of widely varying size. It would be advantageous if a single such tool was adaptable to rivets of diverse different sizes. Avoiding damage to the riveted structural members during use of the prior rivet removers is dependent on operator skill. It would also be advantageous if the tool itself limited penetration into the rivet head and did so in a manner that is compatible with rivets of varying sizes.

Extraction of a rivet requires removal of at least the flange portion of a rivet head at one side of the riveted construction to enable ejection of the rivet at the other side of the construction. Removal of the rivet head with a grinding tool or with a general purpose drill can easily result in damaging of the structural members that are secured together by the rivet. It is difficult to position and control such tools in a manner which will accomplish the desired result without grinding or cutting into the structural members. Such damage may be unacceptable in instances where new rivets will be installed to enable reuse of the riveted structure. An ordinary drill can also be ineffective for rivet removal in instances where the rivet is loose and simply rotates with the drill.

### Problems Solved

Rivet removal therefore has several problems. The need to have a powered tool that can be lightweight enough for an operator to control the jaws and keep from harming the surface. It needs to be powered by various means: electric, battery, pneumatic/compressed air or even as a hydraulic powered devices. Finally, it need a simple configuration that can have its own handle or easily connect to a handle and should be essentially held and operated by the left or right arm during use.

### PRIOR ART

For the special Powered Rivet Cutter device, a novelty search was accomplished. It revealed, as far as known, there are no Powered Rivet Cutter devices or the like. It is believed that this product is unique in its design and technologies. Prior art discovered includes:
A. A U.S. Pat. No. 1,207,601 by Moody issued in 1916 was for a bolt and rivet cutter.
B. A U.S. Pat. No. 2,296,087 by Burns issued in 1942 is a rivet cutter.
C. A U.S. Pat. No. 2,526,955 by Kugler in 1950 was for a cutting tool for blind rivets.
D. A U.S. Pat. No. 2,853,723 by Winslow issued in 1958 was for a rivet removing tool with cutting edges and impact surface.
E. A U.S. Pat. No. 5,318,390 DalBianco issued in 1994 provided a Tool for removing rivets. It is a rivet remover has a casing with a rivet contacting region that is shaped for emplacement on a rivet head and has an interior passage that extends to that region. A rotatable drill bit carrier rod is movable along the passage to cause the bit to cut into the rivet head. The carrier rod may extend out of the casing to enable use of an electric drill motor to drive the tool. The rivet contacting region is on a casing end member which may be disengaged and replaced with any of a series of other end members that have differing rivet contacting regions adapted for conforming to the rivet heads of differing sizes and/or shapes. The preferred embodiment uses an ordinary twist drill bit and apertures in the casing side wall discharge shavings that are drawn into the casing by the bit. An adjustable stop limits penetration of the bit into rivets to avoid damaging of the riveted structure.
F. A U.S. Pat. No. 5,956,992 by Patton was issued in 1999 for a Spreading, crushing or cutting device. It shows a device that is designed to spread, crush or cut pieces of metal or other materials. The device is particularly adaptable for removing material from a vehicle in which is located a trapped accident victim. The device consists of a first arm assembly which functions in combination with an interlocking second arm. The first arm assembly and the second arm operate with a drive-mechanism yoke that pivotally attaches the lower ends on the first arm assembly and the second arm. The device also include a drive yoke which includes a pair of cam pins that traverse a cam slot located on each arm. The drive yoke includes a drive rod connected to a linear actuating mechanism. When the mechanism is in a retracted position, the first arm assembly and the second arm close, and when the mechanism moves upward into a non-retracted position, the two arms open.
G. A U.S. Pat. No. 6,178,643 by Erbrick et al. was issued in 2001 for a Hand-held ratchet action tool. It demonstrates a hand-held, ratchet action tool closes together a pair of jaws. A first jaw is fixed in position. A second jaw includes a plurality of ratchet teeth and is mounted to pivot with respect to the first jaw. The ratchet tool further includes a linkage of four links operatively coupled together and with a motorized drive mechanism. A first pawl is supported on one of the links so as to be engageable with the teeth of the second jaw. The linkage is configured to convert drive motion from the drive mechanism into oscillatory motion of the pawl along the teeth. The first pawl is arranged to drive the working face of the second jaw towards that of the first jaw during the oscillatory motion. A second pawl engages with the teeth to permit the first pawl to be ratcheted back and forth, closing the second jaw on the first jaw. A selector lever is provided to manually disengage the pawls and to permit reopening of the jaws. An inhibitor or stop is located on the second jaw in a position to rotate the selector lever to disengage the second pawl at the end of travel of the second jaw to prevent damage to the mechanism. The inhibitor can be shaped into a handle to support the tool and manually rotate the jaw. The tool can include a drive mechanism or the tool can be configured to be releasably and drivingly connected to a separate drive mechanism such as a conventional electric hand drill. H. A U.S. Pat. No. 6,654,997 by Donovan et al. was issued in 2003 for a Rivet removal tool and method, it shows and teaches a device and method of removing a rivet which has been installed on a work piece. The method includes clamping a hand held device having springs onto the work piece, engaging a drill with a drill bit of the hand held device, the springs applying a pre-load force to the drill bit, operating the drill, thereby causing the springs to apply an increased load force to the drill bit and causing the drill bit to drill into a button of the rivet, unclamping and removing the hand held device from the work piece, and using a compression tool to remove the rivet from the work piece. The compression tool includes a push out portion configured to push out the rivet, and a recess is disposed generally opposite the push out portion for catching the rivet as the rivet is pushed out.
I. A U.S. Pat. No. 6,971,179 by Erbrick that was issued in 2005 for a Cutting tool. Here is shown a cutting tool capable of cutting work pieces which are thicker than what comparably-sized conventional cutting tools are capable of cutting has a jaw with a cutting edge which does not completely abut or overlap over the full length of an opposing edge of a second jaw when the cutting tool is in its closed position. A resulting gap between the opposing edges varies from a maximum at the free end of the cutting edges to zero at a portion of the opposing edges where the edges abut one another. The cutting tool successively notches a work piece, and as the notch deepens, the work piece is advanced toward the abutting portion of the cutting edge and the opposing edge until it is finally severed. The jaws may be operated manually by hand levers or driven by hydraulic, pneumatic or electrical drive mechanisms.
J. A U.S. Pat. No. 7,784,163 by Suarez was issued in 2010 for a Riveted fastener extraction apparatuses and method. Portrayed here is an extraction apparatus for the removal of a riveted fastener from a structure includes a shaft and a cutting element. The cutting element is mechanically coupled to the shaft and is configured to cut a portion of the riveted fastener. The shaft and the cutting element are configured for insertion through an inner channel of the riveted fastener. A method of replacing the riveted fastener from the structure includes inserting the extraction apparatus through the inner channel. The extraction apparatus is rotated. A portion of the riveted fastener that extends through the structure is removed. A head of the riveted fastener is also removed from the structure.
K. A US Patent Application No. 2006/0070245 by Erbrick in 2006 for a Cutting tool with work piece feed mechanism. Shown here is a cutting tool having a work piece feed mechanism includes a first jaw and a second jaw connected together for pivotal movement between a closed position and an open position. The work piece feed mechanism includes first and second ratchet members as well as a slide member adapted to engage a work piece and mounted for movement between a fully extended position and a fully retracted position. Movement of the first and second jaws from the closed position to the open position causes the first ratchet member to operably engage the slide member and incrementally advance the slide member toward the fully retracted position. Movement of the first and second jaws from the open position to the closed position causes the second ratchet member to operably engage the slide member to restrain the slide member from movement toward the fully extended position.

As can be observed, none of the prior art has anticipated or caused one skilled in the art of powered or impact rivet cutters and the like devices to see this new invention by Bowman as obvious to a person skilled in the ordinary art of the industry. The A Special Powered Rivet Cutter device provides an answer to the fast and easy cutting and removal of rivets in most settings. The device is light, fast, easy to hold and handle, and adaptable to many types of power/impact drivers. These features provide a non-anticipated and non-obvious improvement as a tool for cutting and removing rivets.

### SUMMARY OF THE INVENTION

This invention is a Special Powered Rivet Cutter. The preferred embodiment of the device is made of durable and lightweight material and comprised of: (a) a pair of cutting jaws, a first jaw and an opposite jaw, each with cutting edges and each with a pivot apertures and a power connection aperture; (b) a top plate and bottom plate each with a pair of apertures over the pivot apertures; (c) a pair of pivot pins washers and retainer nuts or a means to pivotally fasten the pivot pins to the jaws and washer, the pins being through the top and bottom plates and through each of the first jaw and opposite jaw; and (d) a pair of power pins connected to each other by a pair of span units with left and right handed threads and the pair of span units engaged with an externally threaded driver bar having a driver connection wherein the driver connection can be removably attached to an impact drive unit to power and rotate the drive bar and thereby actuate and pivot the jaws to engage the cutting edges with a rivet or equal fastener and shear the rivet at the point of engagement. The newly invented Special Powered Rivet Cutter can be manufactured at low volumes by very simple means and in high volume production by more complex and controlled systems.

### Objects and Advantages

There are several advantages of the Special Powered Rivet Cutter:

| Item | Advantage |
|---|---|
| 1 | Is light weight |
| 2 | Is faster than cutting by hand only |
| 3 | Can be adapted to various powered impact |
| | drivers |
| 4 | Can be used for rivets and various other |
| | fasteners |
| 5 | Provides flush cut so surface not damaged |
| 6 | Can be powered by electric, battery, pneumatic |
| | and hydraulic drivers |
| 7 | Provides ergonomic assist to avoid carpel |
| | tunnel damage/or aggravation |

Finally, other advantages and additional features of the present Special Powered Rivet Cutter will be more apparent from the accompanying drawings and from the full description of the device. For one skilled in the art of rivet remover devices and other cutting tools and products, it is readily understood that the features shown in the examples with this configured product and device are readily adapted to other types of rivet and cutting tool devices and similar tools or apparatus.

### DESCRIPTION OF THE DRAWINGS—FIGURES

The accompanying drawings, which are incorporated in and constitute a part of this specification, illustrate an embodiment of the Special Powered Rivet Cutter. The drawings together with the summary description given above and a detailed description given below serve to explain the principles of the Special Powered Rivet Cutter device. It is understood, however, that the device is not limited to only the precise arrangements and instrumentalities shown.

FIGS. 1 A through 1 C are sketches of the general Special Power Rivet Cutter for various applications.

FIGS. 2 A through 2 D are sketches of the special power/impact rivet cutter device with components and features noted.

FIGS. 3 A through 3 D are additional sketches of the special power rivet cutter with the components and features shown from generally a top view.

FIGS. 4 A through 4 D are drawings of the special power rivet cutter with components and features shown in a top, side, and end view.

FIGS. 5 A through 5 E are sketches of prior art for fasteners and rivet cutters.

### DESCRIPTION OF THE DRAWINGS—REFERENCE NUMERALS

The following list refers to the drawings:

TABLE B
Reference numbers

| Ref # | Description |
|---|---|
| 30 | special power rivet cutter 30 |
| 33 | Prototype 33 special power rivet cutter 30 |
| 35 | drawings 35 of special power rivet cutter 30 |
| 40 | first jaw 30 |
| 40A | opposite jaw 40A (opposite of jaw 40) |
| 41 | cutting edge 41 of jaw 40, 40A |
| 45 | top connector plate 45 |
| 46 | a pair of apertures 46 on the top bar 45 and |
| | bottom plate 47 for the pivot pins 50, 50A |
| 47 | bottom connector plate 47 |
| 48 | a pair of apertures 48 on the jaws 40, 40A for |
| | the pivot pins 50, 50A |
| 49 | a pair of apertures 49 on the jaws 40, 40A for |
| | the power pins 60, 60A |
| 50 | pivot pin 50 for first jaw 40 and top plate 45 |
| 50A | pivot pin 50A for opposite jaw 40A and top plate |
| | 45 |
| 53 | washer 53 between pin 50, 50A and jaw 40, 40A |
| 53A | nut 53A or a means (or threaded bottom plate 47) |
| | to pivotally fasten the pivot pins 50, 50A to the |
| | jaws 40, 40A and washer 53 47 |
| 60 | power pin 60 at driver bar and rear of first jaw |
| | 40 |
| 60A | power pin 60A at driver bar and rear opposite jaw |
| | 40A |
| 72, 72A | internal threaded span unit 72, 72A a means for |
| | connecting |
| 75 | driver bar 75 |
| 76, 76A | LH/RH threads shaft 76, 76A externally configured |
| | on each respective side on the length of the on |
| | driver bar 75 - these anticipate fine threads or |
| | the like to have superior control and maximum |
| | pressure transfer to cutting edge 41 from power |
| | impact driver 110 |
| 77 | driver connection 77 from driver bar 75 to power |
| | drive 110 - anticipates internal or external nut, |
| | hex drive, square drive on the impact driver |
| | configuration |
| 79 | means 79 to connect bottom strap 47 to handle 80 |
| 80 | handle/grip 80 rebar, solid or tube rod made of |
| | metal, steel, steel alloy, aluminum, plastic, |
| | reinforced plastic, composite material |
| 83 | means 83 to connect multiple handle 80 such as |
| | integral one piece, adhesive, weld, fastener, an |
| | encirclement of wire |
| 85 | grip 85 for handle 80 made of natural or |
| | synthetic rubber, plastic, reinforced plastic, |
| | composite material, leather or the like |
| 91 | prior art device 91 U.S. Pat. No. 1,207,601 |
| 92 | prior art device 92 U.S. Patent Application No. |
| | 20060070245 |
| 93 | prior art device 93 U.S. Pat. No. 5,956,992 |
| 94 | prior art device 94 U.S. Pat. No. 6,971,179 |
| 95 | prior art device 95 U.S. Pat. No. 6,178,643 |
| 100 | rivet 100 or other fastener to be cut |
| 110 | power impact driver 110 electric, pneumatic, |
| | battery or hydraulic |

### DETAILED DESCRIPTION OF PREFERRED EMBODIMENT

The present development is a Special Powered Rivet Cutter device. This invention relates to a Special Powered Rivet Cutter for removing riveted fasteners. More particularly, the present invention is related to a method of extracting a riveted fastener and to apparatuses used to perform such extraction. This is generally related to cutting tools, and, more particularly, to cutting tools used for cutting solid, high strength materials such as metals. Moreover, this invention relates to tools and methods for removing a rivet after it has been installed, and more specifically relates to a rivet removal tool and method which eliminates, or at least substantially reduces, the end load which must be applied to drill out a button and remove a rivet. It relates, therefore, to the removal of rivets from riveted constructions and more particularly to tools for use in such operations.

The advantages for the Special Powered Rivet Cutter are listed above in the introduction. Succinctly these are:
A. Is light weight;
B. Is faster than cutting by hand only;
C. Can be adapted to various powered drivers;
D. Can be used for rivets and various other fasteners;
E. Provides flush cut so surface not damaged;
F. Can be powered by electric, battery, pneumatic and hydraulic drivers; and
G. Provides ergonomic assist to avoid carpel tunnel damage/or aggravation.
   These advantages will be better understood once the description and operation is viewed.

The preferred embodiment of this invention is a Special Powered Rivet Cutter 30 made of durable and lightweight material and comprised of: (a) a pair of cutting jaws, a first jaw 40 and an opposite jaw 40A, each with cutting edges 41 and each with a pivot apertures 48 and a power connection aperture 49; (b) a top plate 45 and bottom plate 47 each with a pair of apertures 46 over the pivot apertures; (c) a pair of pivot pins 50, 50A, washers 53 and retainer nuts 53A or a means (or threaded bottom plate 47) to pivotally fasten the pivot pins 50, 50A to the jaws 40, 40A and washer 53, the pins being through the top and bottom plates and through each of the first jaw and opposite jaw; and (d) a pair of power pins 60, 60A connected to each other by a pair of span units 72, 72A with left and right handed threads 76, 76A and the pair of span units 72, 72A engaged with an externally threaded driver bar 75 (these anticipate fine threads or the like to have superior control and maximum pressure transfer to cutting edge 41 from power impact driver 110 having a driver connection 77 wherein the driver connection 77 can be removably attached to a power air impact drive unit 110 to power and rotate the drive bar 75 and thereby actuate and pivot the jaws to engage the cutting edges with a rivet or equal fastener and shear the rivet at the point of engagement.

This invention relates to a Special Powered Rivet Cutter for removing riveted fasteners. More particularly, the present invention is related to a method of extracting a riveted fastener and to apparatuses used to perform such extraction. A special power rivet cutter made of durable and lightweight material and comprised of: (a) a pair of cutting jaws, a first jaw and an opposite jaw, each with cutting edges and each with a pivot apertures and a power connection aperture; (b) a top plate and bottom plate each with a pair of apertures over the pivot apertures; (c) a pair of pivot pins washers and retainer nuts or a means to pivotally fasten the pivot pins to the jaws and washer, the pins being through the top and bottom plates and through each of the first jaw and opposite jaw; and (d) a pair of power pins connected to each other by a pair of span units with left and right handed threads and the pair of span units engaged with an externally threaded driver bar having a driver connection wherein the driver connection can be removably attached to a power impact drive unit 110 to power and rotate the drive bar and thereby actuate and pivot the jaws to engage the cutting edges with a rivet or equal fastener and shear the rivet at the point of engagement.

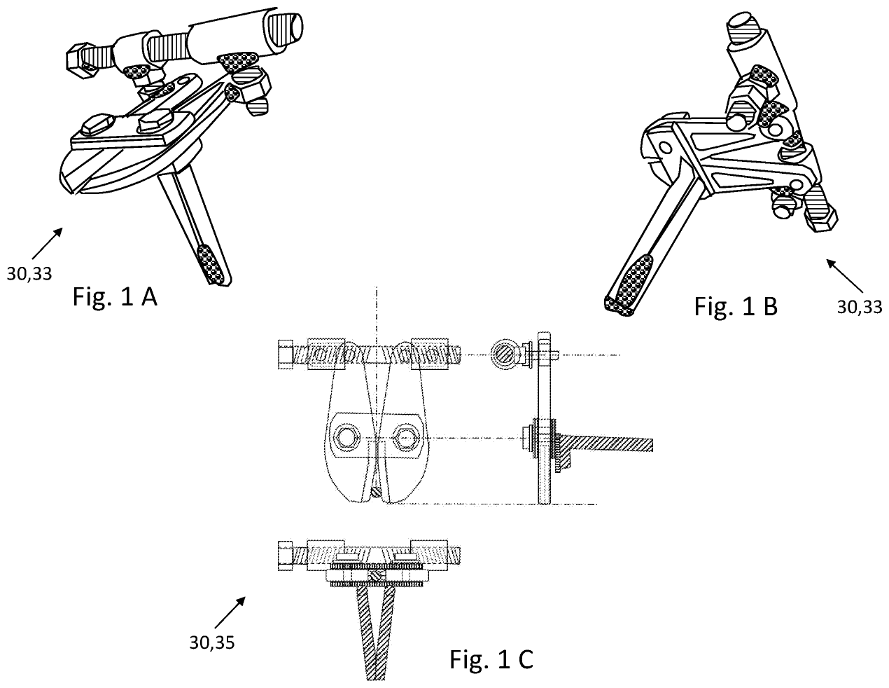

There is shown in FIGS. 1-5 a complete description and operative embodiment of the Special Powered Rivet Cutter 30. In the drawings and illustrations, one notes well that the FIGS. 1-5 demonstrate the general configuration and use of this product. The various example uses are in the below operation and use section.

The accompanying drawings, which are incorporated in and constitute a part of this specification, illustrate an embodiment of the Special Powered Rivet Cutter 30 that is preferred. The drawings together with the summary description given above and a detailed description given below serve to explain the principles of the Special Powered Rivet Cutter device 30. It is understood, however, that the rivet cutting device 30 is not limited to only the precise arrangements and instrumentalities shown. Other examples of rivet and fastener cutting tools and devices are still understood by one skilled in the art of cutting and removal devices and the like to be within the scope and spirit shown here.

FIGS. 1 A through 1 C are sketches of the general Special Power Rivet Cutter 30 for various applications. Shown here are the a special power rivet cutter 30; a prototype 33 special power rivet cutter 30; and a set of drawings 35 of special power rivet cutter 30.

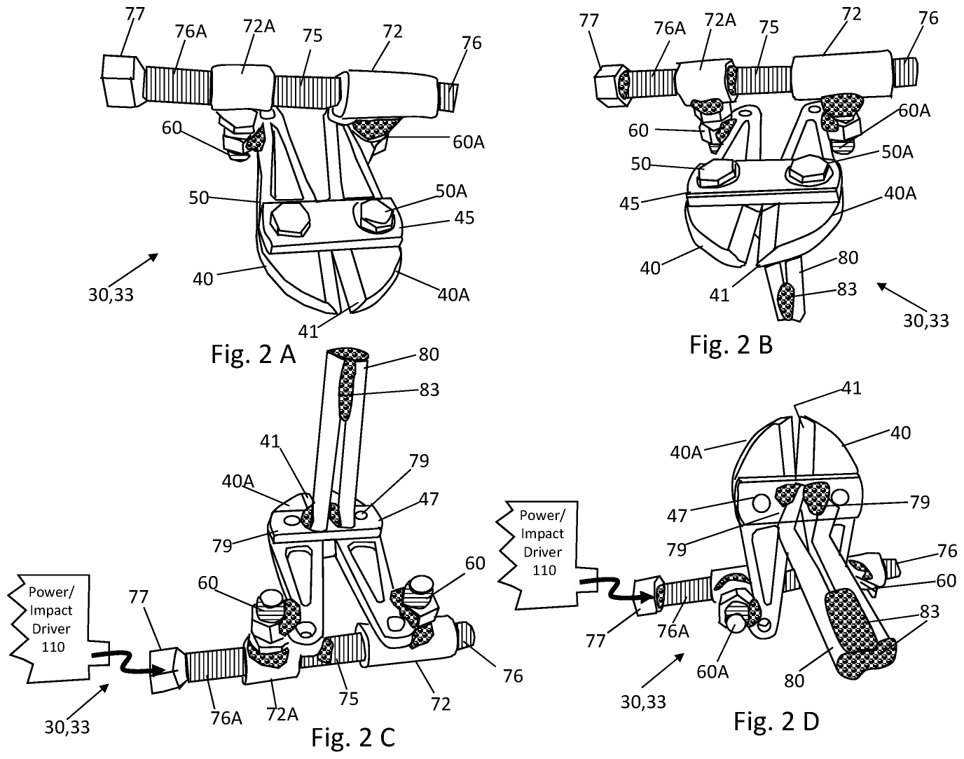

FIGS. 2 A through 2 D are sketches of the special power rivet cutter device with components and features noted. Demonstrated in these sketches are: a special power rivet cutter 30; a prototype 33 special power rivet cutter 30; a first jaw 30; an opposite jaw 40A (opposite of jaw 40); a cutting edge 41 of jaw 40, 40A; a top connector plate 45; a pair of apertures 46 on the top bar 45 and bottom plate 47 for the pivot pins 50, 50A; a bottom connector plate 47; a pair of apertures 48 on the jaws 40, 40A for the pivot pins 50, 50A; a pair of apertures 49 on the jaws 40, 40A for the power pins 60, 60A; a pivot pin 50 for first jaw 40 and top plate 45; a pivot pin 50A for opposite jaw 40A and top plate 45; a washer 53 between pin 50, 50A and jaw 40, 40A; nut 53A or a means (or threaded bottom plate 47) to pivotally fasten the pivot pins 50, 50A to the jaws 40, 40A and washer 53; a power pin 60 at driver bar and rear of first jaw 40; a power pin 60A at driver bar and rear opposite jaw 40A; an internal threaded span unit 72,72A a means for connecting driver bar 75; a pair of left-handed/right handed (LH/RH) threads on a shaft 76,76A externally configured on each respective side on the length of the on driver bar 75 (this thread arrangement anticipates fine threads or the like to have superior control and maximum pressure transfer to cutting edge 41 from power impact driver 110); a driver connection 77 from driver bar 75 to power impact driver 110 (anticipates internal socket or external nut, hex drive, square drive on the impact driver configuration); a means 79 to connect bottom strap 47 to handle 80; a handle/grip 80 rebar, solid or tube rod made of metal, steel, steel alloy, plastic, reinforced plastic, composite material; a means 83 to connect multiple handle 80 such as integral one piece, adhesive, weld, fastener, encirclement of wire; a grip 85 for handle 80 made of natural or synthetic rubber, plastic, reinforced plastic, composite material, leather or the like; a rivet 100 or other fastener to be cut; and a power impact driver 110 electric, pneumatic, battery or hydraulic.

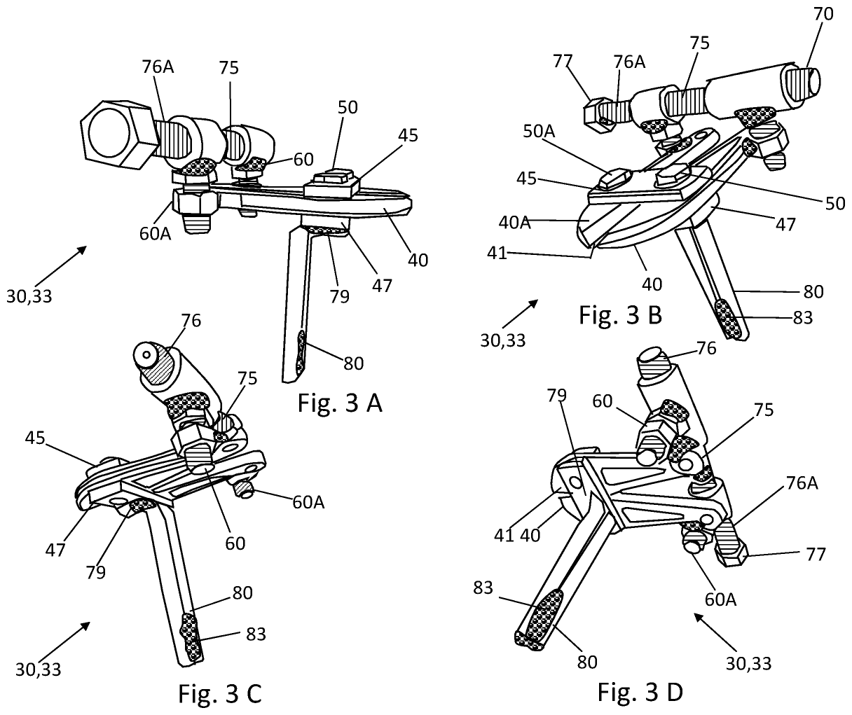

FIGS. 3 A through 3 D are additional sketches of the special power rivet cutter with the components and features shown from generally a top view. Once again in these views are shown: a special power rivet cutter 30; a prototype 33 special power rivet cutter 30; a first jaw 30; an opposite jaw 40A (opposite of jaw 40); a cutting edge 41 of jaw 40, 40A; a top connector plate 45; a pair of apertures 46 on the top bar 45 and bottom plate 47 for the pivot pins 50, 50A; a bottom connector plate 47; a pair of apertures 48 on the jaws 40, 40A for the pivot pins 50, 50A; a pair of apertures 49 on the jaws 40, 40A for the power pins 60, 60A; a pivot pin 50 for first jaw 40 and top plate 45; a pivot pin 50A for opposite jaw 40A and top plate 45; a washer 53 between pin 50, 50A and jaw 40, 40A; nut 53A or a means (or threaded bottom plate 47) to pivotally fasten the pivot pins 50, 50A to the jaws 40, 40A and washer 53; a power pin 60 at driver bar and rear of first jaw 40; a power pin 60A at driver bar and rear opposite jaw 40A; an internal threaded span unit 72,72A a means for connecting driver bar 75; a pair of left-handed/right handed (LH/RH) threads on a shaft 76,76A externally configured on each respective side on the length of the on driver bar 75; a driver connection 77 from driver bar 75 to power impact drive 110 (anticipates internal or external nut, hex drive, square drive on the impact driver configuration); a means 79 to connect bottom strap 47 to handle 80; a handle/grip 80 rebar, solid or tube rod made of metal, steel, steel alloy, plastic, reinforced plastic, [include plastics such as urethane, polyurethane Polyethylene Terephthalate (PETE or PET or PETG), High-Density Polyethylene (HDPE), Polyvinyl Chloride (PVC), Low-Density Polyethylene (LDPE), Polypropylene (PP), Acrylonitrile butadiene styrene (ABS)], composite material; a means 83 to connect multiple handle 80 such as integral one piece, adhesive, weld, fastener; a grip 85 for handle 80 made of natural or synthetic rubber, reinforced plastic, plastic, composite material, leather or the like; a rivet 100 or other fastener to be cut; a power impact driver 110 electric, pneumatic, battery or hydraulic.

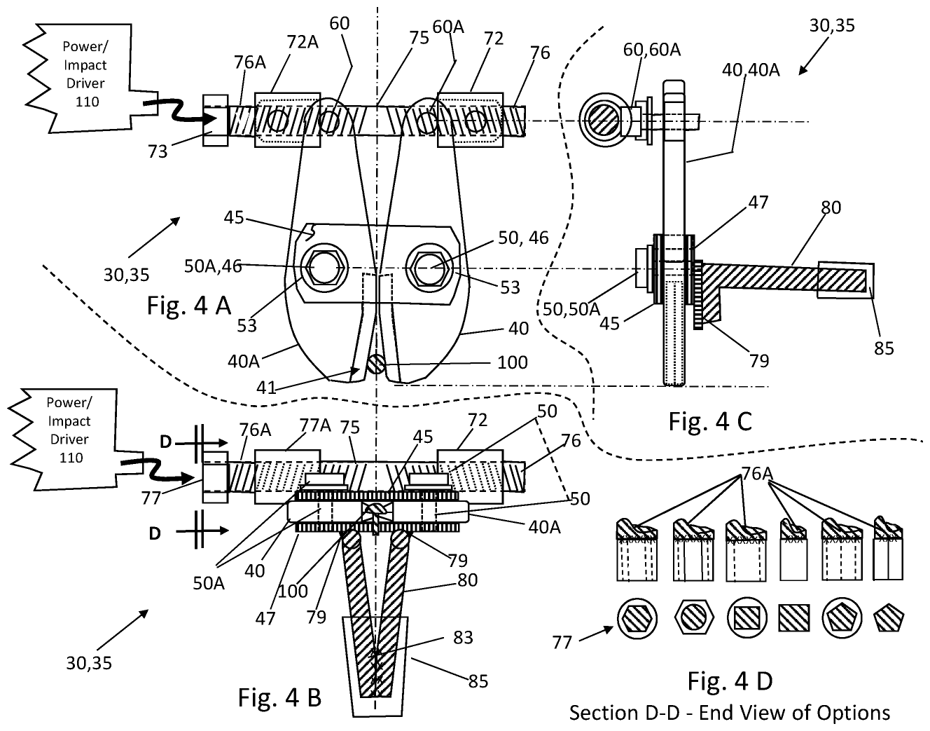

FIGS. 4 A through 4 D are drawings 35 of the special power rivet cutter with components and features shown in a top, side, and end view. These drawings show the following components and features: a special power rivet cutter 30; a set of drawings 35 of special power rivet cutter 30; a first jaw 30; an opposite jaw 40A (opposite of jaw 40); a cutting edge 41 of jaw 40, 40A; a top connector plate 45; a pair of apertures 46 on the top bar 45 and bottom plate 47 for the pivot pins 50, 50A; a bottom connector plate 47; a pair of apertures 48 on the jaws 40, 40A for the pivot pins 50, 50A; a pair of apertures 49 on the jaws 40, 40A for the power pins 60, 60A; a pivot pin 50 for first jaw 40 and top plate 45; a pivot pin 50A for opposite jaw 40A and top plate 45; a washer 53 between pin 50, 50A and jaw 40, 40A; nut 53A or a means (or threaded bottom plate 47) to pivotally fasten the pivot pins 50, 50A to the jaws 40, 40A and washer 53; a power pin 60 at driver bar and rear of first jaw 40; a power pin 60A at driver bar and rear opposite jaw 40A; an internal threaded span unit 72,72A a means for connecting driver bar 75; a pair of left-handed/right handed (LH/RH) threads on a shaft 76,76A externally configured on each respective side on the length of the on driver bar 75 (this thread configuration anticipates fine threads or the like to have superior control and maximum pressure transfer to cutting edge 41 from power impact driver 110); a driver connection 77 from driver bar 75 to power impact drive 110 (anticipates internal or external nut, hex drive, square drive on the impact driver configuration); a means 79 to connect bottom strap 47 to handle 80; a handle/grip 80 rebar, solid or tube rod made of metal, steel, steel alloy, plastic, reinforced plastic, composite material; a means 83 to connect multiple handle 80 such as integral one piece, adhesive, weld, fastener; a grip 85 for handle 80 made of natural or synthetic rubber, plastic, composite material, leather or the like; a rivet 100 or other fastener to be cut; a power impact driver 110 electric, pneumatic, battery or hydraulic. FIG. 4 D shows typical driver connections 77 from driver bar 75 to impact drive 110.

The special power rivet cutter can be made of various materials. For example, and not as a limitation, the device could be manufactured from metal, steel, steel alloys, aluminum, composite materials, and other rigid, high strength and durable materials.

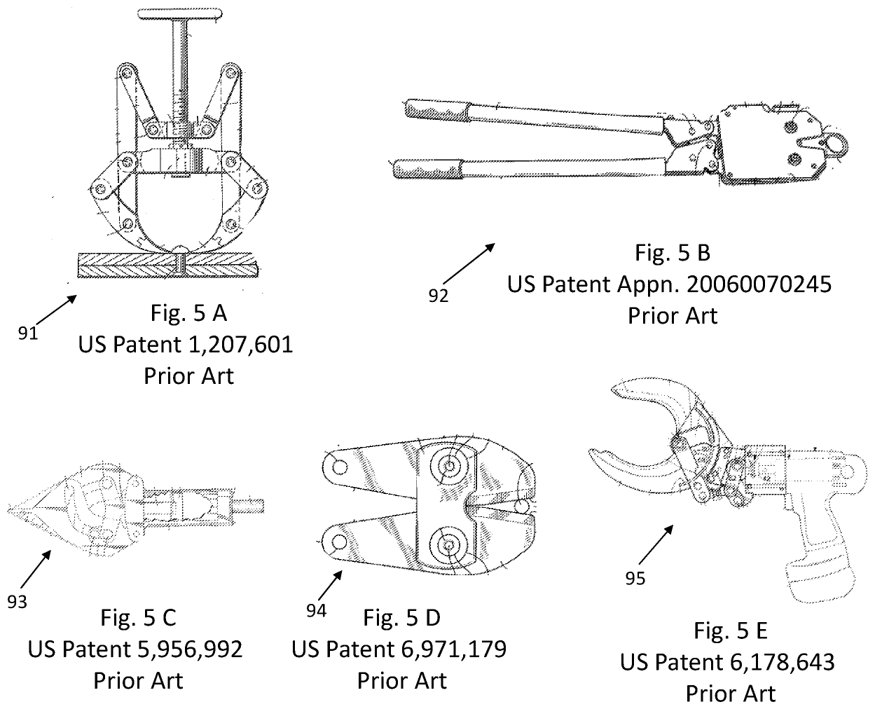

FIGS. 5 A through 5 E are sketches of prior art for fasteners and rivet cutters and the like. Here former patents and applications for devices are shown. These include: prior art device 91 U.S. Pat. No. 1,207,601; prior art device 92 US Patent Application No. 2006/0070245; prior art device 93 U.S. Pat. No. 5,956,992; prior art device 94 U.S. Pat. No. 6,971,179; and prior art device 95 U.S. Pat. No. 6,178,643. As can be seen, the special powered rivet cutter 30 is a unique combination and use as described herein.

The details mentioned here are exemplary and not limiting. Other specific components and manners specific to describing a Special Powered Rivet Cutter device 30 can be added as a person having ordinary skill in the field of the art of rivet and fastener cutting devices and their uses well appreciates.

### Operation of the Preferred Embodiment

The Special Powered Rivet Cutter device 30 has been described in the above embodiment. The manner of how the device operates is described below. One notes well that the description above and the operation described here must be taken together to fully illustrate the concept of the Special Powered Rivet Cutter device 30.

The preferred embodiment is a special power rivet cutter 30 made of durable and lightweight material and comprised of: (a) a pair of cutting jaws, a first jaw 40 and an opposite jaw 40A, each with cutting edges 41 and each with a pivot apertures 48 and a power connection aperture 49; (b) a top plate 45 and bottom plate 47 each with a pair of apertures 46 over the pivot apertures; (c) a pair of pivot pins 50, 50A, washers 53 and retainer nuts 53A or a means to pivotally fasten the pivot pins 50, 50A to the jaws 40, 40A and washer 53, the pins being through the top and bottom plates and through each of the first jaw and opposite jaw; and (d) a pair of power pins 60, 60A connected to each other by a pair of span units 72, 72A with left and right handed threads 76, 76A and the pair of span units 72, 72A engaged with an externally threaded driver bar 75 having a driver connection 77 wherein the driver connection 77 can be removably attached to a power impact drive unit 110 to power and rotate the drive bar 75 and thereby actuate and pivot the jaws to engage the cutting edges with a rivet or equal fastener and shear the rivet at the point of engagement.

The Special Powered Rivet Cutter device 30 is operated by selecting a power impact driver 110 and attaching it to the device 30 at the power connection 77. The operator/user then holds the device 30 in his/her left or right hand by the grip 85 attached to the handle 80. The jaws 40, 40A are the opened by powering the impact driver 110. Once the jaws 40, 40A are open, the edge 41 is placed next to a rivet 100 on a workpiece. The power impact unit 110 again is turned on and the jaws 40, 40A close around the rivet 100 and shear it 100. The device is then removed from the old rivet 100 and workpiece. If the shank of the rivet remains, a simple punch or rod/nail can push the remaining shank out of the workpiece. Then the process is repeated as needed to remove other rivets. One skilled in fastener and cutting tools appreciates that the device 30 can be used with other fasteners such as screws, standard and machine bolts, cotter pins, nails, etc.

With this description it is to be understood that the special powered rivet cutter is not to be limited to only the disclosed embodiment of product shown herein. The features and components of the device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments save been shown and described and that all changes, modifications and equivalents that come within the spirit of the disclosures described heretofore and or/defined by the following claims are desired to be protected.

What is claimed is:

1. A special power rivet cutter (30) made of durable and lightweight material and comprised of:
(a) a pair of cutting jaws, a first jaw (40) and an opposite jaw (40A), each with cutting edges (41) and each with a pivot apertures (48 and a power connection aperture (49);
(b) a top plate (45) and bottom plate (47) each with a pair of apertures (46) over the pivot apertures;
(c) a means to pivotally fasten the pivot pins (50,50A) to the jaws (40, 40A); and
(d) a pair of power pins (60,60A) connected to each other by a pair of span units (72,72A) with left and right handed threads (76,76A) and the pair of span units (72,72A) engaged with an externally threaded driver bar (75) having a driver connection (77)
wherein the driver connection (77) can be removably attached to a power impact drive unit (110) to power and rotate the drive bar (75) and thereby actuate and pivot the jaws to engage the cutting edges with a rivet or equal fastener and shear the rivet at the point of engagement.

2. The special power rivet cutter (30) in claim 1 wherein the cutter (30) is further comprised of a handle (80).

3. The special power rivet cutter (30) in claim 2 wherein the left and right handed threads of the pair of power pins (60,60A) connected to each other by the pair of span units (72,72A) are fine threads.

4. The special power rivet cutter (30) in claim 2 wherein the driver connection (77) is selected from a group consisting of an internal nut socket, an external nut, a hexagonal drive, and a square drive as an impact driver configuration.

5. The special power rivet cutter (30) in claim 2 wherein the means to pivotally fasten the pivot pins (50,50A) to the jaws (40, 40A) is a pair of pivot pins (50,50A), washers (53) and retainer nuts (53A) and washer (53), the pins being through the top and bottom plates and through each of the first jaw and opposite jaw.

6. The special power rivet cutter (30) in claim 2 wherein the type of for the power drive (100) is selected from a group consisting of electric, pneumatic, battery and hydraulic.

7. The special power rivet cutter (30) in claim 2 wherein the durable and lightweight material, of the special power rivet cutter (30), is selected from a group consisting of metal, steel, steel alloy, plastic, reinforced plastic, and a composite material.

8. The special power rivet cutter (30) in claim 2 wherein the handle (80) is further comprised of a grip (85).

9. The special power rivet cutter (30) in claim 8 wherein the grip (85) is made of a material that is selected from the group consisting of a natural rubber, a synthetic rubber, a plastic, a composite material, and a leather.

10. The special power rivet cutter (30) in claim 2 wherein the handle (80) is one piece and integral component.

11. The special power rivet cutter (30) in claim 2 wherein the handle (80) is comprised as a pair of rods.

12. The special power rivet cutter (30) in claim 8 wherein the pair of rods is selected from the group consisting of a pair of rebar rods, a pair of solid rods, and a pair of tubular rods.

13. The special power rivet cutter (30) in claim 8 wherein the handle (80) is further comprised of a means to connect the pair of rods.

14. The special power rivet cutter (30) in claim 10 wherein the means to connect the pair of rods is selected from the group consisting of an adhesive, a weld, an encirclement of wire, and a fastener.

15. The special power rivet cutter (30) in claim 2 wherein the handle is made of a material selected from a group consisting of metal, steel, steel alloy, aluminum, plastic, reinforced plastic and a composite material.

16. A special power rivet cutter (30) made of durable and lightweight material and comprised of:
(a) a pair of cutting jaws, a first jaw (40) and an opposite jaw (40A), each with cutting edges (41) and each with a pivot apertures (48 and a power connection aperture (49);
(b) a top plate (45) and bottom plate (47) each with a pair of apertures (46) over the pivot apertures;
(c) a pair of pivot pins (50,50A), washers (53) and retainer nuts (53A) and a washer (53), the pins being through the top and bottom plates and through each of the first jaw and opposite jaw;
(d) a pair of power pins (60,60A) connected to each other by a pair of span units (72,72A) with left and right handed fine threads (76,76A) and the pair of span units (72,72A) engaged with an externally threaded driver bar (75) having a driver connection (77); and
(e) a handle (80) with a grip (85)
wherein the driver connection (77) can be removably attached to a power impact drive unit (110) to power and rotate the drive bar (75) and thereby actuate and pivot the jaws to engage the cutting edges with a rivet or equal fastener and shear the rivet at the point of engagement.

17. The special power rivet cutter (30) in claim 16 wherein the driver connection (77) is selected from a group consisting of an internal nut socket, an external nut, a hexagonal drive, and a square drive as an impact driver configuration.

18. The special power rivet cutter (30) in claim 16 wherein the type of for the power drive (100) is selected from a group consisting of electric, pneumatic, battery and hydraulic.

19. The special power rivet cutter (30) in claim 16 wherein the durable and lightweight material, of the special power rivet cutter (30), is selected from a group consisting of metal, steel, steel alloy, plastic, reinforced plastic, and a composite material.

20. The special power rivet cutter (30) in claim 16 wherein the grip (85) is made of a material that is selected from the group consisting of a natural rubber, a synthetic rubber, a plastic, a composite material, and a leather.
